(19) United States
(12) Patent Application Publication
(10) Pub. No.: US 2021/0213462 A1
(43) Pub. Date: Jul. 15, 2021

(54) ROTODYNAMIC SEPARATOR FOR MULTIPHASE FLUID WITHOUT A CENTRAL HUB

(71) Applicant: IFP Energies nouvelles, Rueil-Malmaison (FR)

(72) Inventor: Philippe PAGNIER, RUEIL-MALMAISON CEDEX (FR)

(21) Appl. No.: 17/058,993

(22) PCT Filed: May 9, 2019
(86) PCT No.: PCT/EP2019/061975

§ 371 Date: Nov. 25, 2020

(30) Foreign Application Priority Data
May 28, 2018 (FR) 1854520

(51) Int. Cl. B04B 1/06; B04B 5/08

(52) U.S. Cl. CPC B04B 1/06; B04B 5/08

(57) ABSTRACT

The invention relates to a rotodynamic separator (30) for separating a liquid and a gas from a multiphase fluid, notably for use in the petroleum industry. This separator comprises a cylinder (12) freely rotating about an axis (xx), a substantially axial inlet (1) for the multiphase fluid, a liquid outlet (5) and a gas outlet (6). At least one vane assembly (15) arranged along axis (xx), in the direction of circulation (F) of said multiphase fluid, is installed and integral with cylinder (12). Vanes (15) are directed towards axis (xx) of cylinder (12). Furthermore, the inside diameter of vanes (15) decreases progressively, in the part of the separator located upstream from the outlet of the second phase, in the direction of circulation of the multiphase fluid, while remaining larger than the inside diameter of gas outlet (6).

### FIELD OF THE INVENTION

The present invention relates to the field of multiphase separators, enabling separation of two phases, a liquid phase and a gas phase for example, from a multiphase fluid entering the separator.

Such separators are notably used in petroleum applications for hydrocarbon recovery, and more generally in any type of application requiring separation of two liquid/liquid phases of different densities or liquid/gas phases such as, for example, gas processing applications. When the petroleum application is an offshore application, the separators can be used either in so-called “downhole” configurations or in so-called “subsea” configurations, or on platforms. When they are used in wellbores, their outside diameter is constrained by the downhole environment, in particular the wellbore diameter. For subsea configurations, the separators are generally arranged on the seabed and they are connected to pipes allowing the fluid to be conveyed from the well to the surface.

The separators can also be used for onshore applications.

### BACKGROUND OF THE INVENTION

As illustrated in FIG. 1 for example, rotating gas separators 10, also referred to as RGS, comprise, in a pipe 8, two series of blades or vanes 3 and 4 integral with a rotating shaft 2, rotating shaft 2 rotating about axis xx, axis xx corresponding to the axis of pipe 8. The first series is made up of a helix 3 for setting the multiphase fluid into motion and imparting rotation thereto so as to initiate separation. The second series is made up of purely radial blades 4 that centrifuge the liquid in pipe 8, which is stationary. The multiphase fluid flows into separator 10 through inlet 1 and it is conveyed through pipe 8. The first phase, which is liquid, flows out through outlet 5 in the peripheral part and the second phase, which is gaseous, flows out through part 6 close to rotating shaft 2.

These systems have the drawback of requiring a central rotating shaft 2, thus limiting the cross-sectional area of flow. This is particularly limiting for downhole separator applications, the outside diameter of the separator being constrained by the well bottom. This reduction in the cross-sectional area of flow for the fluid induced by the presence of the central shaft results in a limitation of the flow rates in the separator and in an increase in pressure drops.

Furthermore, the succession of the series made up of a helix and of a series made up of purely radial blades generates a great equipment length.

Besides, this system can induce lower fluid pressure at the outlet than at the inlet (induced by pressure drops).

The aim of the present invention is to overcome these drawbacks. It relates to a rotodynamic separator for separating at least two phases, a liquid phase and a gas phase for example, from a multiphase fluid. This separator comprises at least one cylinder freely rotating about the cylinder axis, corresponding to the axis of the separator, an axial inlet for a multiphase fluid, an outlet for at least a first phase and an outlet for at least a second phase. The outlet of the second phase is axial and the outlet of the first phase is arranged around the outlet of the second phase. The separator comprises at least one vane arranged along the cylinder axis, in the direction of circulation of the multiphase fluid. This vane or these vanes are integral with the cylinder, so as to be integrally rotated therewith. The inside diameter of the vanes decreases progressively in the direction of circulation of the fluid, so as to orient the second phase contained in the multiphase fluid towards the central axial outlet. The inside diameter of the vanes remains larger than the diameter of the second phase outlet so as not to hinder the outflow and/or to induce flow disturbance.

### SUMMARY OF THE INVENTION

The invention relates to a rotodynamic separator for separating at least two phases from a multiphase fluid, said rotodynamic separator comprising at least one cylinder freely rotating about the axis of said cylinder, a substantially axial inlet for said multiphase fluid, an outlet for at least a first phase and an outlet for at least a second phase, said outlet of said at least second phase being substantially axial and at the centre of said outlet of said at least first phase, said rotodynamic separator comprising at least one vane, each of said vanes being arranged along said axis of said cylinder, in the direction of circulation of said multiphase fluid, each of said vanes being integral with said cylinder, each of said vanes being directed towards the axis of said cylinder. Besides, the inside diameter of each of said vanes decreases progressively, in the part of said separator arranged upstream from said outlet of said at least second phase, in the direction of circulation of said multiphase fluid, while remaining larger than the inside diameter of said outlet of said at least second phase.

Advantageously, each of said vanes is inclined with respect to the radial direction, the inner radial end of each of said vanes being located downstream, in the direction of circulation of said multiphase fluid, from the outer radial end of said vane.

Preferably, each of said vanes has an aerodynamic profile.

According to an embodiment of the separator according to the invention, said separator comprises a plurality of vanes, and said vanes are evenly distributed over the section of said cylinder.

Advantageously, the first phase is a liquid phase and the second phase is a gas phase.

According to a variant of the separator according to the invention, the tangents of each of said vanes at the junctions thereof with said cylinder are inclined with respect to the radial direction of said cylinder, preferably said tangents of each of said vanes start at the junction of said vane and said cylinder towards said axis of said cylinder and downstream, in the direction of circulation of said multiphase fluid.

According to another embodiment of the separator according to the invention, a central hub is arranged on the downstream part of the rotodynamic separator, in the direction of circulation of said multiphase fluid, said central hub being integrally fastened to said cylinder by at least a second part of said vanes, said outlet of said at least second phase being arranged in said central hub, said second part of said vanes extending from the outside diameter of said central hub to the inside diameter of said cylinder.

Advantageously, at least one vane is positioned inside the central hub, in said outlet of said at least second phase.

According to an embodiment of the separator according to the invention, the rotodynamic separator comprises an electric or hydraulic machine, said electric or hydraulic machine driving a rotating shaft, said rotating shaft driving said central hub in rotation.

Preferably, the separator comprises an electric machine, the rotor of said electric machine being arranged on the outer periphery of said cylinder of said rotodynamic separator, so as to drive said cylinder.

The invention also relates to the use of the rotodynamic separator according to one of the above features for separating a multiphase fluid in a downhole application, in a subsea application or in an onshore application for hydrocarbon recovery or gas reinjection into the well.

### BRIEF DESCRIPTION OF THE FIGURES

Other features and advantages of the device according to the invention will be clear from reading the description hereafter of embodiments given by way of non-limitative example, with reference to the accompanying figures wherein:

FIG. 1 illustrates a separator according to the prior art,

FIG. 2 illustrates an embodiment of a rotodynamic separator according to the invention,

FIG. 3a illustrates a second embodiment of a rotodynamic separator according to the invention,

FIG. 3b illustrates a third embodiment of a rotodynamic separator,

FIG. 4 illustrates a longitudinal sectional view of the vanes of an embodiment according to the invention,

FIG. 5 illustrates a perspective view of another embodiment of the vanes according to the invention, and

FIG. 6 illustrates the profile of the helically-shaped vanes.

### DETAILED DESCRIPTION OF THE INVENTION

The invention relates to a rotodynamic separator for separating at least two phases, a liquid phase and a gas phase for example, from a multiphase fluid, or two liquid phases of different densities. A separator is understood to be a means enabling dissociation of the phases of a multiphase fluid. This rotodynamic separator, referred to as “separator” hereafter, comprises at least one cylinder freely rotating about the axis of the cylinder, which corresponds to the axis of the separator, a substantially axial inlet for the multiphase fluid, an outlet for at least a first phase and an outlet for at least a second phase. A rotodynamic separator is understood to be a separator for which separation is performed from a rotational motion, generating different centrifugal effects in the phases. The outlet of the second phase is substantially axial and at the centre of the outlet of the first phase.

The separator also comprises at least one vane arranged along the cylinder axis, in the direction of circulation of the multiphase fluid. These vanes are integral with the cylinder and directed towards the cylinder axis, starting from the junction thereof with the cylinder. Furthermore, the inside diameter of each vane can progressively decrease, in the direction of circulation of the fluid, while remaining larger than the inside diameter of the outlet of the second phase, so that this second phase can be conveyed towards the outlet in an undisturbed flow.

Moreover, the separator can be free of a central hub, the vanes being integral with the cylinder arranged on the outside diameter of the vanes. The cylinder thus surrounds the vanes. This embodiment without a central hub is particularly interesting since the absence of a central hub makes it possible not to restrict the fluid passageway on the one hand and not to increase pressure drops on the other.

The vanes also serve to exert a centrifugal effect on the first phase (liquid phase for example), of greater density than the second phase (gas phase for example). Therefore, the first phase is directed outwards, i.e. towards the cylinder wall, through the centrifugation induced by the vanes.

By means of such a separator, the incoming multiphase fluid flows through the vanes. Optionally, through progressive decrease of the inside diameter of at least a first part of these vanes, the second phase is progressively conveyed to the centre (i.e. towards the cylinder axis), while the first phase is oriented centrifugally outwards. Thus, the second phase leaves through an axial outlet arranged at the centre of the separator. The outlet of the first phase is around the outlet of the second phase. It may be axial or radial. For space-constrained downhole applications notably, an axial outlet is advantageously provided for the first phase.

The inside diameter of each vane can decrease progressively in the upstream part of the separator, more particularly in the part of the separator located upstream from the outlet of the second phase.

The inside diameter of the vanes however remains larger than the outlet diameter of the second phase so as not to disturb the flow in this zone.

In the part of the separator located at the outlet of the second phase, the inside diameter of the vanes may remain constant.

The vanes being integral with the freely rotating cylinder, the separator does not need a central axis to drive the vanes in rotation. The cross-sectional area of flow of the fluid in the cylinder is thus increased, which allows to increase the maximum flow rate through the separator and to reduce friction losses.

According to the invention, the cylinder, the vanes and the outlet of the second phase are coaxial.

For ease of description, we consider hereafter that the first phase is a liquid phase and the second phase is a gas phase. However, this does not limit in any way the invention to a separator of this type. The invention could also be used to separate two liquids of distinct densities. Indeed, one operating principle is a centrifugal effect associated with a radially generated pressure gradient between the part comprising the vanes and the part comprising no vanes. It is therefore based on a density difference between different phases contained in a fluid. The separator according to the invention could thus be used to separate two phases of different densities from a multiphase fluid.

Preferably, the first phase can be a liquid phase and the second phase can be a gas phase. The separator is particularly suitable for separating a liquid and a gas.

Advantageously, the vanes can be inclined with respect to the radial direction. The inner radial end of each vane can be located downstream, in the direction of circulation of the multiphase fluid, from the outer radial end of this vane. Thus, the vanes are advantageously cambered so as to convey the gas to the centre under the effect of the radial pressure gradient and to centrifuge the liquid towards the outside diameter.

Preferably, the vanes may have an aerodynamic profile. An axial pressure difference can thus be induced in the system, thereby allowing, in addition to the separation of the liquid and gas phases, to increase the pressure at the separator outlet in relation to the inlet pressure.

Preferably, if the separator comprises a plurality of vanes, the vanes may be evenly distributed over the section of the cylinder. The spacing between the vanes over an orthoradial section, i.e. a section orthogonal to the axis of rotation of the cylinder, can be regular. For example, two vanes can be arranged at 180°, four vanes at 90° or six vanes at 60°. Operation of the system is thus improved by a good wheel balance.

According to an embodiment of the invention, the tangents of each vane at the junctions thereof with the cylinder can be inclined with respect to the radial direction of the cylinder. Preferably, the tangents of each vane start at the junctions thereof with the cylinder towards the cylinder axis and downstream, in the direction of circulation of the multiphase fluid. Thus, the vanes are inclined from the junction thereof with the cylinder. This induces a vane camber from the junction thereof with the cylinder. This camber provides better conveyance of the gas to the centre of the cylinder and an increase in the overpressure effect, hence improved separation.

Preferably, the thickness of the vanes decreases from the junction thereof with the housing towards the inside. Thus, mechanical strength, notably at the vane/housing connection, is provided.

According to a variant of the invention, a central hub can be used in the downstream part of the separator, in the direction of circulation of the multiphase fluid. The central hub can be integrally fastened to the cylinder by at least part of the vanes. This part of the vanes, in direct rigid connection with the hub, is located in the downstream part of the vanes, the gas phase outlet being arranged in the central hub. The hub can thus be used to transmit the rotation to the cylinder, through the agency of the vanes. According to this configuration, this part of the vanes extends from the outside diameter of the central hub to the inside diameter of the cylinder.

Preferably, the central hub is hollow and it can then serve as a wall separating the liquid outlet and the gas outlet, the gas outlet being located inside the central hub, on a section that may be for example either circular or annular. The liquid outlet is arranged between the central hub and the cylinder. It may be annular or it may consist for example of the channels formed by the second part of the vanes, preferably evenly distributed, between the central hub and the cylinder.

According to another variant of the invention, the central section for the central gas outlet can be provided with another series of vanes, independent of the vanes fastened to the cylinder. This second series of vanes notably serves to increase the gas pressure.

According to an embodiment of the invention, the rotodynamic separator can comprise an electric or hydraulic machine, a rotating shaft, itself driving the central hub in rotation. Thus, rotation of the cylinder and of the vanes is induced by the electric or hydraulic machine through the agency of the rotating shaft and the cylinder. The rotating shaft is coaxial with the hub, itself coaxial with the cylinder, and it is arranged inside the hub. Furthermore, the rotating shaft and the hub may be integral. In this variant of the invention, the rotating shaft and the hub move forward at the vanes, only on the second part of the vanes. They do not move forward at the level of the first part of the vanes, they remain recessed from this zone so as not to limit the cross-section of flow of the fluid in this first part of the vanes and not to disturb the fluid flow in this zone.

Alternatively, the rotodynamic separator can comprise an electric machine whose rotor is arranged on the outer periphery of the cylinder of the rotodynamic separator so as to drive the cylinder. This configuration is particularly advantageous. Indeed, the separator no longer needs a rotating shaft to transmit the rotation to the cylinder. Thus, the gas outlet integrated in the central hub is not blocked by the presence of the rotating shaft. The cross-section of flow of the gas outlet is therefore increased, thus allowing the fluid flow rate to be increased in the separator, and it can be provided with a second series of vanes, thus allowing compression of the gas. Furthermore, the absence of rotating shaft in the hub prevents gas flow disturbance, which enables the phase separation performances of the system to be improved.

The invention also relates to the use of the rotodynamic separator according to one of the above features (or one of the above feature combinations) for separating a multiphase fluid in a downhole application, in a subsea application or in an onshore application for hydrocarbon recovery or gas reinjection into the well. Indeed, a separator according to one of the above features can be more readily integrated in a constrained environment such as a well bottom for example. Moreover, these features enable petroleum fluid separation, which fluid may notably contain liquid or gaseous hydrocarbons, water and other gases such as CO₂ or H₂S.

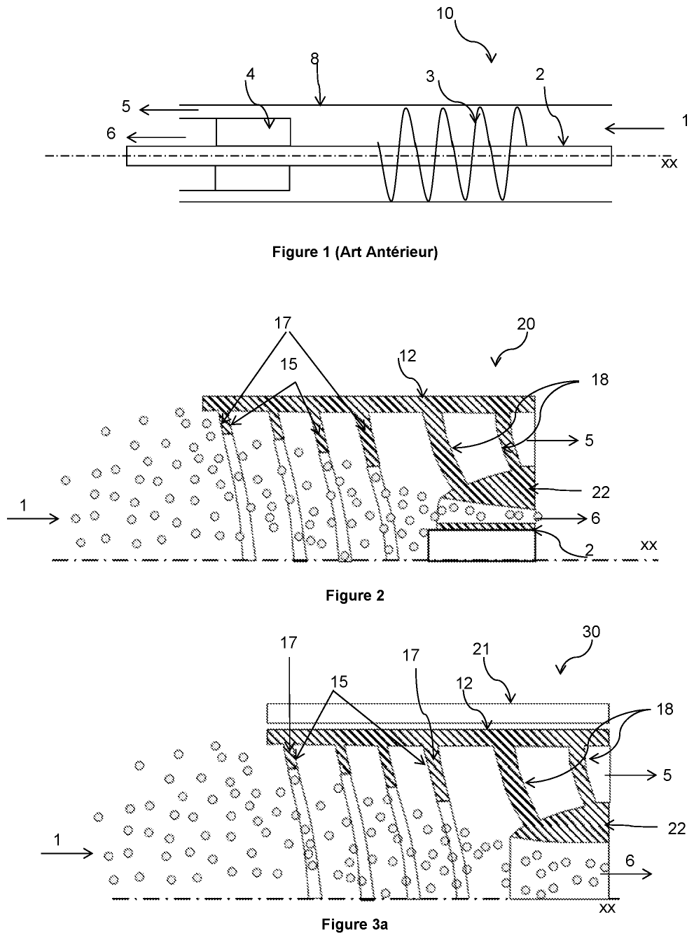

Besides, a separator according to the invention enables the overall length thereof to be reduced in relation to a RGS type separator, as illustrated for example in FIG. 1.

FIG. 2 schematically illustrates, by way of non-limitative example, an embodiment of a separator 20 according to the invention. In this figure, the gas bubbles present in the multiphase fluid are illustrated by circles. This separator 20 comprises a cylinder 12 and vanes 15. Each vane 15 is integrally attached to cylinder 12, cylinder 12 thus surrounding vanes 15. This attachment can for example be obtained by welding vanes 15 onto cylinder 12, by bulk machining or by additive manufacturing.

A radial end of vanes 15 is located at the junction thereof with cylinder 12. The second radial end is located inside cylinder 12. Vanes 15 are therefore directed towards the centre of cylinder 12.

Furthermore, vanes 15 are inclined backward, in the direction of circulation of the fluid. The inner radial end of vanes 15 is located downstream from the outer radial end thereof (also corresponding to the junction with cylinder 12), in the longitudinal direction of axis xx and in the direction of circulation of the fluid.

Besides, vanes 15 have, at least in a first part 17, an inner radial end progressively leading the gas (marked by small circles in FIG. 2) from inlet 1 to gas outlet 6. For example, vanes 15 can consist of a helical part whose outside diameter corresponds to that of cylinder 12 and whose inner part would be cut by a cone from upstream to downstream, in the direction of circulation of the fluid.

The inside diameter of vanes 15 in at least first part 17 of the vanes, i.e. the part of the vanes located upstream from central hub 22, remains always larger than the inside diameter of gas outlet 6, corresponding for example to the inside diameter of central hub 22. Thus, the gas is correctly sent towards gas outlet 6 and the vanes do not disturb the gas flow over the section of gas outlet 6.

Furthermore, vanes 15 have a substantially helical shape around axis xx of cylinder 12. The helix is formed around axis xx as shown in FIG. 6. In this figure, angle T corresponds to the angular position of the vane at the junction thereof with the cylinder, in a section orthogonal to axis xx. For two different longitudinal positions of the vane along axis xx, the variation of this angle corresponds to angle G. The rotational motion of the fluid is thus increased, which allows the centrifugal effect providing separation of the liquid and the gas (or more generally of the phases of different densities) to be increased. A perspective view of these vanes is shown in FIG. 5.

Vanes 15 can be evenly spaced out.

The liquid contained in the multiphase fluid at inlet 1 is sent to liquid outlet 5 through a centrifugal effect induced by vanes 15 rotating about axis xx of cylinder 12.

A rotating shaft 2 is arranged at the rear of vanes 15 and recessed from the first part where they are located. This rotating shaft 2 enables transmission of a torque and of a rotational motion from a machine, an electric or hydraulic machine for example (not visible in FIG. 2). Rotating shaft 2 drives a central hub 22 in rotation. This drive can be achieved by a rigid connection between rotating shaft 2 and central hub 22, but also by any means known to the person skilled in the art. Central hub 22 is integrally fastened to cylinder 12 by a second part 18 of the vanes. This part of the vanes is located downstream from the first part described above. Unlike the first part, in this second part, the vanes extend from the inside diameter of the cylinder to the outside diameter of the hub. The purpose of this second part 18 of the vanes is to transmit the rotation and the torque to cylinder 12. It is also intended to provide good coaxiality between cylinder 12 and central hub 22 for proper operation of the system. Thus, cylinder 12, central hub 22 and rotating shaft 2 are coaxial.

Central hub 22 and rotating shaft 2 do not move axially into the zone comprising the first part of the vanes, the first part consisting of the vane zone where the inside diameter of the vanes decreases progressively. On the other hand, central hub 22 and rotating shaft 2 remain recessed from this first part of the vanes. Therefore, in the first part of the separator, no central hub or shaft obstructs the central fluid passageway. Thus, central hub 22 and rotating shaft 2 do not reduce the cross-section of flow of the multiphase fluid in line with the first part of the vanes, and they do not disturb the flow in this zone. This improves the efficiency of the phase separation device.

Rotating shaft 2 is arranged inside hub 22, rotating shaft 2 and hub 22 being coaxial. Gas outlet 6 is located in a space between central hub 22, which is hollow, and rotating shaft 2. Preferably, outlet 6 is located in the annular space defined between the inside diameter of central hub 22 and the outside diameter of rotating shaft 2. Thus, the cross-section of flow of the gas is maximal.

The section of liquid outlet 5 is also preferably annular, located between the inside diameter of cylinder 12 and the outside diameter of central hub 22. Thus, the cross-section of flow of liquid outlet 5 is maximal.

Preferably, the extension of the curve induced by the inner radial ends of the various vanes 15 is substantially oriented by the outside diameter of gas outlet 6. In a way, these inner radial ends form a channel leading the gas to gas outlet 6. Thus, the outside diameter of gas outlet 6 is in the extension of the curve generated by the inner radial ends of vanes 15.

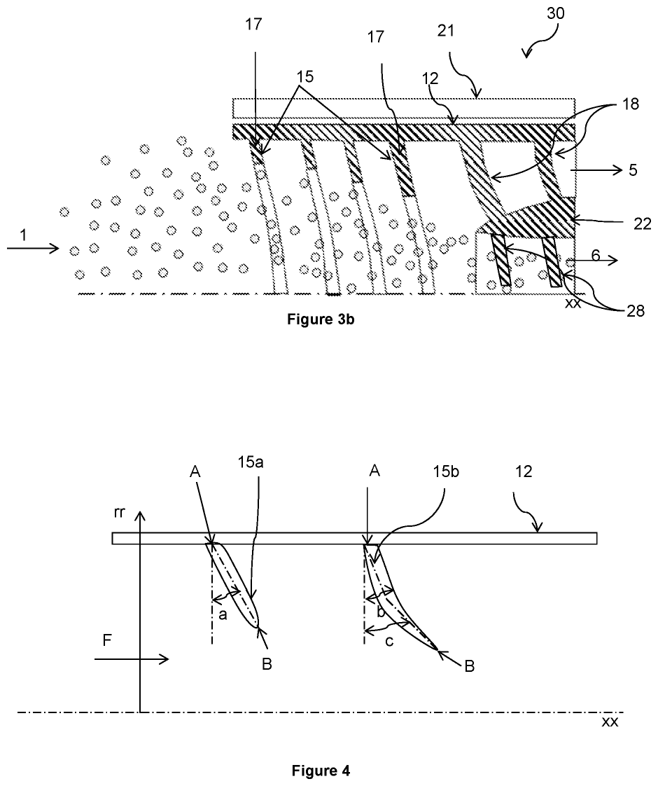

FIG. 3a schematically illustrates, by way of non-limitative example, a second embodiment of a separator 30 according to the invention. In this figure, the gas bubbles present in the multiphase fluid are illustrated by circles. In this figure, the elements identical to those of FIG. 2 are not described.

Unlike FIG. 2, this embodiment comprises no rotating shaft 2. Thus, the cross-section of flow of gas outlet 6 can be cylindrical and defined by the inside diameter of central hub 22. This embodiment allows to increase the gas flow rate at the separator outlet and to eliminate the disturbances at the gas outlet that might be induced by the presence of rotating shaft 2.

No rotating shaft 2 being used, the rotation of cylinder 12 is directly driven by an electric machine 21 whose rotor is integral with cylinder 12. The stator of the electric machine is located on the outer periphery of cylinder 12. This electric machine can notably be a permanent-magnet machine.

This embodiment is particularly advantageous for increasing the gas flow rate at the separator outlet and for improving the system efficiency.

FIG. 3b schematically illustrates, by way of non-limitative example, a third embodiment of a separator 30 according to the invention. In this figure, the gas bubbles present in the multiphase fluid are illustrated by circles. In this figure, the elements identical to those of FIG. 2 or FIG. 3a are not described.

In this figure, a second series of vanes 28, distinct from vanes 15, is arranged in central hub 22. This second series of vanes 28 is inclined: the inner radial end of the second series of vanes 28 is located downstream, in the direction of circulation of the fluid, from the outer radial end of the second series of vanes 28. The inclination of these vanes provides compression of the fluid. The inside diameter of the second series of vanes 28 can be non-zero. Besides, the thickness of this second series of vanes 28 decreases as a function of the diameter. Thus, the thickness is maximal at the junction of the second series of vanes 28 with central hub 22, and it is minimal at the inside diameter. The mechanical strength of this vane is thus ensured.

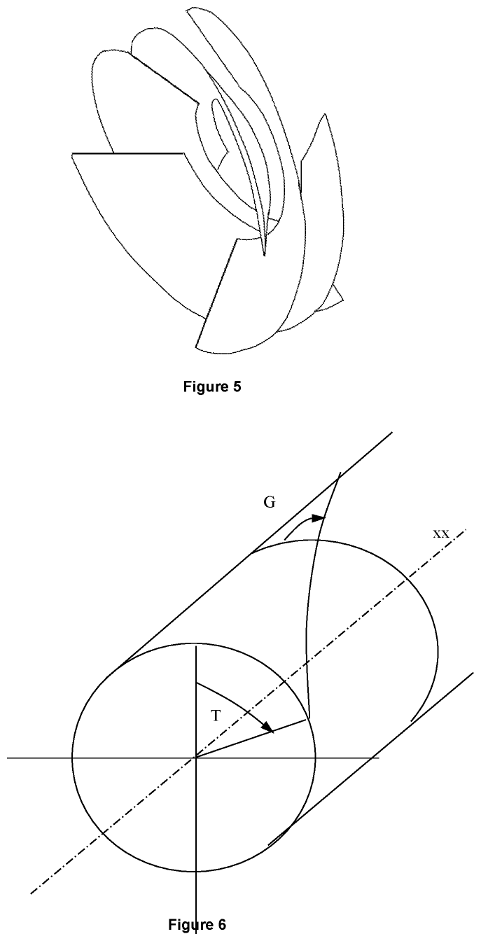

FIG. 4 schematically illustrates, by way of non-limitative example, vane configurations.

Vanes 15a, 15b have aerodynamic profiles so as to orient the liquid towards the outside and the gas towards axis xx of cylinder 12 in order to separate these phases. The radial direction is represented by axis rr.

Furthermore, vanes 15a and 15b are inclined from their outer radial end corresponding to the junction A thereof with cylinder 12. Due to this inclination, inner radial end B of the vanes is located at the rear of outer radial end A, in the axial direction and in the direction of the circulating fluid flow F.

This inclination of vane 15a can induce an angle a between vane 15a and radial axis rr, substantially constant on vane 15a.

Alternatively, the inclination of vane 15a/15b can be progressive or provided discontinuously in several zones, for example, via a first angle b between vane 15b and radial axis rr, then a second angle c between vane 15b and radial axis rr, as visible on second vane 15b, in the direction of flow F (also referred to as direction of circulation of the fluid) in FIG. 4. Thus, vane 15b consists of two zones, a first zone of constant slope b and a second zone of constant slope c. Vane 15b could thus consist of several zones of constant slope, or of a single zone whose slope varies progressively. In this case, the derivative of the slope is a continuous curve, with no discontinuity. The absence of discontinuity prevents flow disturbances, which would be synonymous with loss in device efficiency.

Vanes 15a and 15b exhibit a slope a, b from their junction A (also corresponding to their outer radial end) with cylinder 12. In other words, slope a, b in a plane defined by the radial axis and the longitudinal axis xx at the tangent to vane 15a, 15b, i.e. junction A of vane 15a, 15b with cylinder 12 is non-zero, slope a, b being defined as the angle between the radial axis and the direction of vane 15a, 15b. The tangents of vanes 15a, 15b at their junctions A with cylinder 12 form a non-zero angle with the radial axis of the vane; preferably, this angle is between 5° and 85°, and more preferably between 20° and 60°, thus providing better phase separation performances.

The various vanes 15 of a separator can have identical or different slopes a, b, c.

1. A rotodynamic separator for separating at least two phases from a multiphase fluid, the rotodynamic separator comprising at least one cylinder freely rotating about the axis (xx) of the cylinder, a substantially axial inlet for the multiphase fluid, an outlet for at least a first phase and an outlet for at least a second phase, the outlet of the at least second phase being substantially axial and at the centre of the outlet of the at least first phase, the rotodynamic separator comprising at least one vane, each of the vanes being arranged along the axis (xx) of the cylinder, in the direction of circulation (F) of the multiphase fluid, each of the vanes being integral with the cylinder, each of the vanes being directed towards axis (xx) of the cylinder, wherein the inside diameter of each of the vanes decreases progressively, in the part of the separator arranged upstream from the outlet of the at least second phase, in the direction of circulation (F) of the multiphase fluid, while remaining larger than the inside diameter of the outlet of the at least second phase.

2. A rotodynamic separator as claimed in claim 1, wherein each of the vanes is inclined with respect to the radial direction, the inner radial end (B) of each of the vanes being located downstream, in the direction of circulation (F) of the multiphase fluid, from the outer radial end (A) of the vane.

3. A rotodynamic separator as claimed in claim 1, wherein each of the vanes has an aerodynamic profile.

4. A rotodynamic separator as claimed in claim 1, wherein the separator comprises a plurality of vanes, and the vanes are evenly distributed over the section of the cylinder.

5. A rotodynamic separator as claimed in claim 1, wherein the first phase is a liquid phase and the second phase is a gas phase.

6. A rotodynamic separator as claimed in claim 1, wherein the tangents of each of the vanes at the junctions thereof (A) with the cylinder are inclined with respect to the radial direction of the cylinder, preferably the tangents of each of the vanes start at junction (A) of the vane and the cylinder towards the axis (xx) of the cylinder and downstream, in the direction of circulation (F) of the multiphase fluid.

7. A rotodynamic separator as claimed in claim 1, wherein a central hub is arranged on the downstream part of rotodynamic separator, in the direction of circulation (F) of the multiphase fluid, the central hub being integrally fastened to the cylinder by at least a second part of the vanes, the outlet of the at least second phase being arranged in the central hub, the second part of the vanes extending from the outside diameter of the central hub to the inside diameter of the cylinder (12).

8. A rotodynamic separator as claimed in claim 7, wherein at least one vane is positioned inside the central hub, in the outlet of the at least second phase.

9. A rotodynamic separator as claimed in claim 7, comprising an electric or hydraulic machine, the electric or hydraulic machine driving a rotating shaft, the rotating shaft driving the central hub in rotation.

10. A rotodynamic separator as claimed in claim 1, comprising an electric machine, the rotor of the electric machine being arranged on the outer periphery of the cylinder of the rotodynamic separator, so as to drive the cylinder.

11. Use of rotodynamic separator as claimed in claim 1 for separating a multiphase fluid in a downhole application, in a subsea application or in an onshore application for hydrocarbon recovery or gas reinjection into the well.

12. A method, comprising separating a multiphase fluid in a downhole application, in a subsea application or in an onshore application for hydrocarbon recovery or gas reinjection into the well using the rotodynamic separator as claimed in claim 1.
